(19) United States
(12) Patent Application Publication
(10) Pub. No.: US 2023/0318021 A1
(43) Pub. Date: Oct. 5, 2023

(54) Method for Preparing Multi-Tab Battery

(71) Applicant: HGB BATTERY CO.,LTD, Zhuhai (CN)

(72) Inventors: Changqing HU, Zhuhai (CN); Ming Zhao, Zhuhai (CN); Qiang Luo, Zhuhai (CN)

(21) Appl. No.: 18/102,789

(22) Filed: Jan. 30, 2023

(30) Foreign Application Priority Data
Apr. 2, 2022 (CN) 202210353872.0

(51) Int. Cl. H01M 10/0525; H01M 50/534; H01M 50/538

(52) U.S. Cl. CPC H01M 10/0525; H01M 50/534; H01M 50/538

(57) ABSTRACT

Disclosed is a method for preparing a multi-tab battery. Each of a positive pole piece and a negative pole piece is provided with two or more groups of current collectors, aluminum strips or nickel strips that are used as tabs are arranged on the corresponding current collectors by means of spot welding, so as to form two or more groups of tab leading-out ends; then, the two or more groups of tab leading-out ends are overlapped through a winding manner; tab dual-output or multi-output is used for improving the problem that the consistency of winding tightness of wound battery cores is poor; the contact area between the tabs and the current collectors is effectively improved, the rate discharge capabilities of lithium-ion batteries is improved, and the charging efficiency is greatly improved, thus realizing fast charge.

### TECHNICAL FIELD

The present disclosure relates to the technical field of lithium-ion battery processing, and in particular to a method for preparing a multi-tab battery.

### BACKGROUND

Compared with lead acid batteries, nickel-metal hydride batteries, and nickel-cadmium batteries, lithium-ion batteries have the advantages of higher energy density, small self discharge, long cycle life, and the like and currently have been widely applied to the field of consumer electronics and power batteries.

At present, wound battery cores with a winding type structure and stacked battery cores are commonly used as battery cores of polymer lithium-ion batteries. The stacked battery core is obtained by cutting positive and negative pole pieces and a diaphragm into specified sizes, then stacking the positive pole piece, the diaphragm, and the negative pole piece into a small battery core monomer, and then stacking and connecting the small battery core monomers in parallel to form a large battery core; and the wound battery core is obtained by a process of fixing split pole pieces on a winding needle, and winding the positive pole piece, the negative pole piece, and the diaphragm into a battery core along with the rotation of the winding needle. The wound battery cores and the stacked battery cores have the following advantages and disadvantages due to different processing technologies: 1: different internal resistances: the battery cores produced by using a stacking type process have relatively low internal resistances, while the wound battery cores have relatively high internal resistances; this is because the wound battery cores usually have a single tab, while the stacked battery cores can be regarded as multi-tab ones, which can greatly reduce their internal resistances; 2: different capacity attenuations of the battery cores: finished-product battery cores produce different heat in charge-discharge cycles and speeds of the capacity attenuations of the battery cores are different due to the different internal resistances, and the stacked battery cores have the plurality of tabs so that the battery capacity attenuations of the stacked battery cores are slower; 3: different rates of the battery cores: the stacked battery cores are equivalent to parallel connection of the plurality of pole pieces, and large-current discharge can be more easily finished within short time, which facilitates the rate performance of batteries; however, the process for the wound battery cores is just the opposite, and their single tabs result in slightly worse rate performance; and 4: different difficult levels of processing: the process for the wound battery cores is relatively simple to operate and can be rapidly finished regardless of semi-automation or full automation, the rate of finished products is high, and the process is suitable for mass production; and however, the process for the stacked battery cores has a relatively high complexity degree, manual operation is time-consuming and laborious, and industrialization is difficult to achieve for automation due to equipment problems.

Therefore, the tabs of existing wound battery cores are led out from one part of the pole pieces, and only one positive tab and one negative tab exist, respectively, so that the contact area between the tabs and current collectors is relatively small, resulting in that the rate performance of the wound battery cores is worse than that of the stacked battery cores; in an actual charging process, the welded single tab has a large internal resistance so that the charging time is long and fast charge cannot be realized; and how to improve the process and structure of the existing wound battery cores so as to make them have both high rate performance and high volume energy density at the same time is a technical problem to be urgently solved for the existing wound battery cores.

### SUMMARY

An embodiment of the present disclosure provides a method for preparing a multi-tab battery, which uses tab dual-output or multi-output for improving the problem that the consistency of winding tightness of the wound battery cores is poor, and simultaneously improves the contact area between the tabs and the current collectors and improves the rate discharge capabilities of the lithium-ion batteries.

The method for preparing a multi-tab battery according to an embodiment of the present disclosure includes the following steps:
S1: preparing strip-shaped positive pole piece and negative pole piece according to preset sizes, respectively;
S2: arranging a plurality of positive current collectors, which are located on an upper edge opening of the positive pole piece and overlapped on the same position after winding, along a length direction of the positive pole piece according to a curvature change of a jelly roll after winding and at sequentially scaled-up intervals;
S3: welding a positive tab, which is vertical with respect to the length direction of the positive pole piece and overlapped on the same position after winding, on each positive current collector on the positive pole piece;
S4: arranging a plurality of negative current collectors, which are located on a lower edge opening of the negative pole piece and overlapped on the same position after winding, along a length direction of the negative pole piece according to the curvature change of the jelly roll after winding and at sequentially scaled-up intervals, the negative current collectors being staggered relative to the positive current collectors;
S5: welding a negative tab, which is vertical with respect to the length direction of the negative pole piece and overlapped on the same position after winding, on each negative current collector on the negative pole piece;
S6: stacking the positive pole piece welded with the positive tabs, a diaphragm, and the negative pole piece welded with the negative tabs in sequence and winding to form the cylindrical jelly roll;
S7: wrapping the cylindrical jelly roll with a high-temperature adhesive tape into a whole body, and packaging the whole body and molding to obtain a battery core;
S8: placing the wound battery core into a cylindrical battery case;
S9: on upper and lower openings of the battery case, making the stacked positive tabs penetrate through a rear insulation cover of a tab groove on an upper insulation sheet, and the stacked negative tabs penetrate through a rear insulation cover of a tab groove on a lower insulation sheet; and
S10: covering the upper insulation sheet and the positive tabs, and the lower insulation sheet and the negative tabs on the battery case with top caps, respectively, so as to finish the manufacturing of the battery.

Further, the positive tabs in step S3 are aluminum tabs.

Further, the negative tabs in step S5 are nickel tabs.

One or more technical solutions provided in the embodiments of the present disclosure at least have the following technical effects or advantages:
since each of the positive pole piece and the negative pole piece is provided with two or more groups of current collectors, aluminum strips or nickel strips that are used as the tabs are arranged on the corresponding current collectors by means of spot welding to form two or more groups of tab leading-out ends, and the two or more groups of tab leading-out ends are overlapped through a winding manner. Compared with traditional welded single-tab lithium batteries, the plurality of tabs are overlapped after winding, the contact area between the tabs and the current collectors can be effectively improved, and the resistance is effectively reduced in a charging process, so that the rate discharge capability is improved, and the charging efficiency is greatly improved, thus realizing the fast charge.

Moreover, the wound battery cores obtained by using this preparation method have the advantages of low internal resistances and good rate performance of stacked batteries, and the problems that the rate performance of the wound battery cores is poor and the voltage of the stacked batteries is low are effectively solved. At the same time, a winding procedure can be used for processing the battery cores, and is suitable for mass production.

### DETAILED DESCRIPTION

The content of the present disclosure is further described below with reference to specific examples.

A method for preparing a multi-tab battery includes the following steps:
S1: strip-shaped positive pole piece and negative pole piece are prepared according to preset sizes, respectively.
S2: a plurality of positive current collectors are arranged, which are located on an upper edge opening of the positive pole piece and overlapped on the same position after winding, along a length direction of the positive pole piece according to a curvature change of a jelly roll after winding and at sequentially scaled-up intervals.
S3: a positive tab is welded, which is vertical with respect to the length direction of the positive pole piece and overlapped on the same position after winding, on each positive current collector on the positive pole piece; and the positive pole piece is an aluminum strip body, and the positive tabs are aluminum tabs.
S4: a plurality of negative current collectors are arranged, which are located on a lower edge opening of the negative pole piece and overlapped on the same position after winding, along a length direction of the negative pole piece according to the curvature change of the jelly roll after winding and at sequentially scaled-up intervals, the negative current collectors being staggered relative to the positive current collectors.
S5: a negative tab is welded, which is vertical with respect to the length direction of the negative pole piece and overlapped on the same position after winding, on each negative current collector on the negative pole piece; and the negative pole piece is a nickel strip body, and the negative tabs are nickel tabs.
S6: the positive pole piece welded with the positive tabs, a diaphragm, and the negative pole piece welded with the negative tabs are stacked in sequence and wound to form the cylindrical jelly roll.
S7: the cylindrical jelly roll with a high-temperature adhesive tape is wrapped into a whole body, and the whole body is packaged and molded to obtain a battery core.
S8: the wound battery core is placed into a cylindrical battery case.
S9: on upper and lower openings of the battery case, the stacked positive tabs penetrate through a rear insulation cover of a tab groove on an upper insulation sheet, and the stacked negative tabs penetrate through a rear insulation cover of a tab groove on a lower insulation sheet.
S10: the upper insulation sheet and the positive tabs, and the lower insulation sheet and the negative tabs on the battery case are covered with top caps, respectively, so as to finish the manufacturing of the battery.

The preparation method can process the battery cores by using batch winding, and has the advantages of low internal resistances and good rate performance of stacked batteries. Compared with traditional welded single-tab lithium batteries, the plurality of tabs are overlapped after winding, the contact area between the tabs and the current collectors can be effectively improved, and the resistance is effectively reduced in a charging process, so that the rate discharge capability is improved, and the charging efficiency is greatly improved.

The above embodiment is merely a preferred embodiment of the present disclosure, but is not used to limit the scope of implementation of the present disclosure, except for situations listed in the specific embodiment; and any equivalent change in accordance with the method and the principle of the present disclosure shall fall within the scope of protection of the present disclosure.

What is claimed is:

1. A method for preparing a multi-tab battery, comprising the following steps:
S1: preparing strip-shaped positive pole piece and negative pole piece according to preset sizes, respectively;
S2: arranging a plurality of positive current collectors, which are located on an upper edge opening of the positive pole piece and overlapped on the same position after winding, along a length direction of the positive pole piece according to a curvature change of a jelly roll after winding and at sequentially scaled-up intervals;
S3: welding a positive tab, which is vertical with respect to the length direction of the positive pole piece and overlapped on the same position after winding, on each positive current collector on the positive pole piece;
S4: arranging a plurality of negative current collectors, which are located on a lower edge opening of the negative pole piece and overlapped on the same position after winding, along a length direction of the negative pole piece according to the curvature change of the jelly roll after winding and at sequentially scaled-up intervals, the negative current collectors being staggered relative to the positive current collectors;
S5: welding a negative tab, which is vertical with respect to the length direction of the negative pole piece and overlapped on the same position after winding, on each negative current collector on the negative pole piece;
S6: stacking the positive pole piece welded with the positive tabs, a diaphragm, and the negative pole piece welded with the negative tabs in sequence and winding to form the cylindrical jelly roll;
S7: wrapping the cylindrical jelly roll with a high-temperature adhesive tape into a whole body, and packaging the whole body and molding to obtain a battery core;
S8: placing the wound battery core into a cylindrical battery case;
S9: on upper and lower openings of the battery case, making the stacked positive tabs penetrate through a rear insulation cover of a tab groove on an upper insulation sheet, and the stacked negative tabs penetrate through a rear insulation cover of a tab groove on a lower insulation sheet; and
S10: covering the upper insulation sheet and the positive tabs, and the lower insulation sheet and the negative tabs on the battery case with top caps, respectively, so as to finish the manufacturing of the battery.

2. The method for preparing a multi-tab battery according to claim 1, wherein the positive tabs in step S3 are aluminum tabs.

3. The method for preparing a multi-tab battery according to claim 1, wherein the negative tabs in step S5 are nickel tabs.
